(19) United States
(12) Patent Application Publication
(10) Pub. No.: US 2023/0167022 A1
(43) Pub. Date: Jun. 1, 2023

(54) MULTI-COLORED GLASS SUBSTRATES AND METHODS OF MAKING SAME

(71) Applicant: CORNING INCORPORATED, CORNING, NY (US)

(72) Inventors: Candy Elizabeth Card, Corning, NY (US); Eileen Marie Fanning, Corning, NY (US); Xiaoju Guo, Pittsford, NY (US); Lina Ma, Corning, NY (US); Lei Yuan, Painted Post, NY (US); Minghui Zhang, Painted Post, NY (US)

(21) Appl. No.: 17/994,531

(22) Filed: Nov. 28, 2022

Related U.S. Application Data
(60) Provisional application No. 63/283,600, filed on Nov. 29, 2021.

(51) Int. Cl. C03C 23/00; C03C 4/02; C03C 1/06; C03C 21/00

(52) U.S. Cl. CPC C03C 23/0025; C03C 4/02; C03C 1/06; C03C 21/002; C03C 23/007; C03C 2204/00

(57) ABSTRACT

A method of forming a multi-colored glass substrate comprises: irradiating a first region of a glass substrate with a first high energy source to form a first irradiated glass substrate; and subjecting the irradiated glass substrate to a first heat treatment to form a first heat treated glass substrate, wherein the first heat treated glass substrate comprises a second region having a different transmittance color coordinate in the CIELAB color space, as measured at an article thickness of 1.33 mm under F2 illumination and a 10° standard observer angle, than the first region.

This application claims the benefit of priority of U.S. Provisional Application Ser. No. 63/283,600 filed on Nov. 29, 2021, the content of which is relied upon and incorporated herein by reference in its entirety.

### FIELD

The present specification generally relates to multi-colored glass substrates and, in particular, to methods of making multi-colored substrates including irradiation and heat treatment.

### TECHNICAL BACKGROUND

Aluminosilicate glass substrates may exhibit superior ion-exchangeability and drop performance. Various industries, including the consumer electronics industry, desire multi-colored and/or patterned materials with the same or similar strength and fracture toughness properties. However, conventional methods may not produce the desired color and/or pattern.

Accordingly, a need exists for an alternative method to produce multi-colored glass substrates having high strength and fracture toughness.

### SUMMARY

According to a first aspect A1, a method of forming a multi-colored glass substrate may comprise: irradiating a first region of a glass substrate with a first high energy source to form a first irradiated glass substrate; and subjecting the first irradiated glass substrate to a first heat treatment to form a first heat treated glass substrate, wherein the first heat treated glass substrate comprises a second region having a different transmittance color coordinate in the CIELAB color space, as measured at an article thickness of 1.33 mm under F2 illumination and a 10° standard observer angle, than the first region.

A second aspect A2 includes the method according to the first aspect A1, wherein the first high energy source comprises an X-ray source or an ultrafast laser beam.

A third aspect A3 includes the method according to the second aspect A2, wherein the X-ray source has a wavelength greater than or equal to 0.01 nm and less than or equal to 10 nm.

A fourth aspect A4 includes the method according to the second aspect A2 or third aspect A3, wherein the X-ray source has a power less than or equal to 4000 W.

A fifth aspect A5 includes the method according to the second aspect A2, wherein the ultrafast laser beam has a pulse width greater than or equal to 10⁻¹² s and less than or equal to 10⁻¹⁵ s.

A sixth aspect A6 includes the method according to the second aspect A2 or the fifth aspect A5, wherein the ultrafast laser beam has a peak intensity greater than or equal to 10¹³ W/cm².

A seventh aspect A7 includes the method according to any one of the second aspect A2, the fifth aspect A5, or the sixth aspect A6, wherein the ultrafast laser beam has a wavelength greater than or equal to 300 nm and less than or equal to 1100 nm.

An eighth aspect A8 includes the method according to any one of the second aspect A2 or the fifth through seventh aspects A5-A7, wherein the ultrafast laser beam has a pulse energy greater than or equal to 0.5 μJ and less than or equal to 30 μJ.

A ninth aspect A9 includes the method according to any one of the second aspect A2 or the fifth through eighth aspects A5-A8, wherein the ultrafast laser beam has a peak power greater than or equal to 0.05 MW and less than or equal to 20 MW.

A tenth aspect A10 includes the method according to any one of the first through ninth aspects A1-A9, wherein the irradiating the glass substrate is conducted for a time period greater than or equal to 0.001 hours and less than or equal to 1 hour.

An eleventh aspect A11 includes the method according to any one of the first through tenth aspects A1-A10, wherein the first heat treatment comprises an isothermal heat treatment or a gradient heat treatment.

A twelfth aspect A12 includes the method according to any one of the first through eleventh aspects A1-A11, wherein the first heat treatment is conducted at a temperature of greater than or equal to 500° C. to less than or equal to 900° C. and for a time period greater than or equal to 0.5 hours and less than or equal to 12 hours.

A thirteenth aspect A13 includes the method according to any one of the first through twelfth aspects A1-A12, wherein the glass substrate comprises Au.

A fourteenth aspect A14 includes the method according to any one of the first through thirteenth aspects A1-A13, wherein the glass substrate comprises: greater than or equal to 50 mol % and less than or equal to 70 mol % SiO₂; greater than or equal to 5 mol % and less than or equal to 25 mol % Al₂O₃; greater than or equal to 0 mol % and less than or equal to 15 mol % B₂O₃; greater than or equal to 1 mol % and less than or equal to 20 mol % Li₂O; greater than or equal to 0 mol % and less than or equal to 15 mol % Na₂O; greater than or equal to 0 mol % and less than or equal to 3 mol % K₂O; greater than or equal to 0 mol % and less than or equal to 3 mol % MgO; greater than or equal to 0 mol % and less than or equal to 3 mol % ZnO; greater than or equal to 0 mol % and less than or equal to 3 mol % ZrO₂; greater than or equal to 0 mol % and less than or equal to 1 mol % SnO₂; greater than or equal to 0 mol % and less than or equal to 1 mol % Fe₂O₃; and greater than or equal to 0.00001 mol % and less than or equal to 0.01 mol % Au.

A fifteenth aspect A15 includes the method according to any one of the first through fourteenth aspects A1-A14, the method further comprising subjecting the glass substrate to a pre-heat treatment prior to irradiating the glass substrate.

A sixteenth aspect A16 includes the method according to any one of the first through fifteenth aspects A1-A15, the method further comprising disposing a first mask between the glass substrate and the first high energy source prior to irradiating the glass substrate to form the second region, wherein the first mask is opaque to the first high energy source.

A seventeenth aspect A17 includes the method according to the sixteenth aspect A16, the method further comprising removing the first mask after irradiating the glass substrate.

An eighteenth aspect A18 includes the method according to any one of the first through seventeenth aspects A1-A17, the method further comprising: irradiating the first heat treated glass substrate with a second high energy source to form a second irradiated glass substrate.

A nineteenth aspect A19 includes the method according to the eighteenth aspect A18, the method further comprising disposing a second mask between the first heat treated glass substrate and the second high energy source prior to irradiating the first heat treated glass substrate, wherein the second mask is opaque to the second high energy source, and, after the irradiating with the second high energy source, the second irradiated glass substrate comprises a third region, the third region having a different transmittance color coordinate in the CIELAB color space, as measured at an article thickness of 1.33 mm under F2 illumination and a 10° standard observer angle, than at least one of the first region and the second region.

A twentieth aspect A20 includes the method according to the nineteenth aspect A19, the method further comprising removing the second mask after irradiating the first heat treated glass substrate.

A twenty-first aspect A21 includes the method according to any one of the eighteenth through twentieth aspects A18-A20, the method further comprising: subjecting the second irradiated glass substrate to a second heat treatment to form a second heat treated glass substrate.

A twenty-second aspect A22 includes the method according to any one of the first through twentieth aspects A1-A20, the method further comprising strengthening the glass substrate in an ion-exchange bath at a temperature greater than or equal to 350° C. to less than or equal to 500° C. for a time period greater than or equal to 2 hours to less than or equal to 12 hours to form an ion-exchanged glass substrate.

A twenty-third aspect A23 includes the method according to the twenty-second aspect A22, wherein the ion-exchange bath comprises KNO₃.

A twenty-fourth aspect A24 includes the method according to the twenty-third aspect A23, wherein the ion-exchange bath comprises NaNO₃.

According to a twenty-fifth aspect A25, a method of forming a multi-colored glass substrate may comprise: subjecting a glass substrate to a first heat treatment to form a first heat treated glass substrate; and irradiating a first region of the first heat treated glass substrate with a first high energy source to form a first irradiated glass substrate, wherein the first irradiated glass substrate comprises a second region having a different transmittance color coordinate in the CIELAB color space, as measured at an article thickness of 1.33 mm under F2 illumination and a 10° standard observer angle, than the first region.

A twenty-sixth aspect A26 includes the method according to the twenty-fifth aspect A25, wherein the first high energy source comprises an X-ray source or an ultrafast laser beam.

A twenty-seventh aspect A27 includes the method according to the twenty-sixth aspect A26, wherein the X-ray source has a wavelength greater than or equal to 0.01 nm and less than or equal to 10 nm.

A twenty-eighth aspect A28 includes the method according to the twenty-sixth aspect A26 or twenty-seventh aspect A27, wherein the X-ray source has a power less than or equal to 4000 W.

A twenty-ninth aspect A29 includes the method according to the twenty-eighth aspect A28, wherein the ultrafast laser beam has a pulse width greater than or equal to 10¹² s and less than or equal to 10⁻¹⁵ s.

A thirtieth aspect A30 includes the method according to the twenty-sixth aspect A26 or twenty-ninth aspect A29, wherein the ultrafast laser beam has a peak intensity greater than or equal to 10¹³ W/cm².

A thirty-first aspect A31 includes the method according to any one of the twenty-seventh aspect A27, twenty-ninth aspect A29, or thirtieth aspect A30, wherein the ultrafast laser beam has a wavelength greater than or equal to greater than or equal 300 nm and less than or equal to 1100 nm.

A thirty-second aspect A32 includes the method according to any one of the twenty-sixth aspect A26 or the twenty-ninth through thirty-first aspects A29-A31, wherein the ultrafast laser beam has a pulse energy greater than or equal to 0.5 μJ and less than or equal to 30 μJ.

A thirty-third aspect A33 includes the method according to any one of the twenty-sixth aspect A26 or the twenty-ninth through thirty-second aspects A29-A32, wherein the ultrafast laser beam has a peak power greater than or equal to 0.05 MW and less than or equal to 20 MW.

A thirty-fourth aspect A34 includes the method according to any one of the twenty-fifth through thirty-third aspects A25-A33, wherein the irradiating the glass substrate is conducted for a time period greater than or equal to 0.001 hours and less than or equal to 1 hour.

A thirty-fifth aspect A35 includes the method according to any one of the twenty-fifth through thirty-fourth aspects A25-A34, wherein the first heat treatment comprises an isothermal heat treatment or a gradient heat treatment.

A thirty-sixth aspect A36 includes the method according to any one of the twenty-fifth through thirty-fifth aspects A25-A35, wherein the first heat treatment is conducted at a temperature of greater than or equal to 500° C. to less than or equal to 900° C. and for a time period greater than or equal to 0.5 hours and less than or equal to 12 hours.

A thirty-seventh aspect A37 includes the method according to any one of the twenty-fifth through thirty-sixth aspects A25-A36, wherein the glass substrate comprises Au.

A thirty-eighth aspect A38 includes the method according to any one of the twenty-fifth through thirty-seventh aspects A25-A37, wherein the glass substrate comprises: greater than or equal to 50 mol % and less than or equal to 70 mol % SiO₂; greater than or equal to 5 mol % and less than or equal to 25 mol % Al₂O₃; greater than or equal to 0 mol % and less than or equal to 15 mol % B₂O₃; greater than or equal to 1 mol % and less than or equal to 20 mol % Li₂O; greater than or equal to 0 mol % and less than or equal to 15 mol % Na₂O; greater than or equal to 0 mol % and less than or equal to 3 mol % K₂O; greater than or equal to 0 mol % and less than or equal to 3 mol % MgO; greater than or equal to 0 mol % and less than or equal to 3 mol % ZnO; greater than or equal to 0 mol % and less than or equal to 3 mol % ZrO₂; greater than or equal to 0 mol % and less than or equal to 1 mol % SnO₂; greater than or equal to 0 mol % and less than or equal to 1 mol % Fe₂O₃; and greater than or equal to 0.00001 mol % and less than or equal to 0.01 mol % Au.

A thirty-ninth aspect A39 includes the method according to any one of the twenty-fifth through thirty-eighth aspects A25-A38, the method further comprising disposing a first mask between the first heat treated glass substrate and the first high energy source prior to irradiating the first heat treated glass substrate to form the second region, wherein the first mask is opaque to the first high energy light source.

A fortieth aspect A40 includes the method according to the thirty-ninth aspect A39, the method further comprising removing the first mask after irradiating the first heat treated glass substrate.

A forty-first aspect A41 includes the method according to any one of the twenty-fifth aspect through fortieth aspects A25-A40, the method further comprising: subjecting the first irradiated glass substrate to a second heat treatment to form a second heat treated glass substrate.

A forty-second aspect A42 includes the method according to the forty-first aspect A41, the method further comprising: irradiating the second heat treated glass substrate with a second high energy source to form a second irradiated glass substrate.

A forty-third aspect A43 includes the method according to the forty-second aspect A42, the method further comprising disposing a second mask between the second heat treated glass substrate and the second high energy source prior to irradiating the second heat treated glass substrate, wherein the second mask is opaque to the second high energy source, and, after irradiating with the second high energy source, the second irradiated glass substrate comprises a third region, the third region having a different transmittance color coordinate in the CIELAB color space, as measured at an article thickness of 1.33 mm under F2 illumination and a 10° standard observer angle, than at least one of the first region and the second region.

A forty-fourth aspect A44 includes the method according to the forty-third aspect A43, the method further comprising removing the second mask after irradiating the second heat treated glass substrate.

A forty-fifth aspect A45 includes the method according to the twenty-fifth through forty-fourth aspects A25-A44, the method further comprising strengthening the glass substrate in an ion-exchange bath at a temperature greater than or equal to 350° C. to less than or equal to 500° C. for a time period greater than or equal to 2 hours to less than or equal to 12 hours to form an ion-exchanged glass substrate.

A forty-sixth aspect A46 includes the method according to the forty-fifth aspect A45, the method further comprising further comprising strengthening the glass substrate in an ion-exchange bath at a temperature greater than or equal to 350° C. to less than or equal to 500° C. for a time period greater than or equal to 2 hours to less than or equal to 12 hours to form an ion-exchanged glass substrate.

A forty-seventh aspect A47 includes the method according to the forty-sixth aspect A46, wherein the ion-exchange bath comprises NaNO₃.

Additional features and advantages of the multi-colored glass substrate forming methods described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a flow diagram of a method of forming a multi-colored glass substrate, according to one or more embodiments shown and described herein;

FIG. 2 schematically depicts a step of the method of forming a multi-colored glass substrate shown in FIG. 1;

FIG. 3 schematically depicts another step of the method of forming a multi-colored glass substrate shown in FIG. 1;

FIG. 4 schematically depicts another step of the method of forming a multi-colored glass substrate shown in FIG. 1;

FIG. 5 schematically depicts another step of the method of forming a multi-colored glass substrate shown in FIG. 1;

FIG. 6 is a flow diagram of another method of forming a multi-colored glass substrate, according to one or more embodiments shown and described herein;

FIG. 7 schematically depicts a step of the method of forming a multi-colored glass substrate shown in FIG. 6;

FIG. 8 schematically depicts another step of the method of forming a multi-colored glass substrate shown in FIG. 6;

FIG. 9 schematically depicts another step of the method of forming a multi-colored glass substrate shown in FIG. 6;

FIG. 10 schematically depicts another step of the method of forming a multi-colored glass substrate shown in FIG. 6;

FIG. 11 is a plan view of an electronic device incorporating any of the multi-colored glass substrates, according to one or more embodiments shown and described herein;

FIG. 12 is a perspective view of the electronic device of FIG. 11;

FIG. 13 schematically depicts an exemplary multi-colored glass substrate, according to one or more embodiments shown and described herein;

FIG. 14 is a high angle annular dark field (HAADF) image of a region the multi-colored glass substrate of FIG. 13;

FIG. 15 is an HAADF image of another region of the multi-colored glass substrate of FIG. 13;

FIG. 16 schematically depicts another exemplary multi-colored glass substrate, according to one or more embodiments shown and described herein;

FIG. 17 schematically depicts another exemplary multi-colored glass substrate, according to one or more embodiments shown and described herein; and

FIG. 18 schematically depicts another exemplary multi-colored glass substrate, according to one or more embodiments shown and described herein.

### DETAILED DESCRIPTION

Reference will now be made in detail to various embodiments of methods of irradiating and heat treating glass substrates to produce multi-colored glass substrates. According to embodiments, a method of forming a multi-colored glass substrate includes irradiating a first region of a glass substrate with a first high energy source to form a first irradiated glass substrate; and subjecting the irradiated glass substrate to a first heat treatment to form a first heat treated glass substrate. The first heat treated glass substrate may comprise a second region having a different transmittance color coordinate in the CIELAB color space, as measured at an article thickness of 1.33 mm under F2 illumination and a 10° standard observer angle, than the first region.

In other embodiments, a method of forming a multi-colored glass substrate is provided, the method includes subjecting a glass substrate to a first heat treatment to form a first heat treated glass substrate; and irradiating a first region of the first heat treated glass substrate with a first high energy source to form a first irradiated glass substrate. The first irradiated glass substrate may comprise a second region having a different transmittance color coordinate in the CIELAB color space, as measured at an article thickness of 1.33 mm under F2 illumination and a 10° standard observer angle, than the first region.

Various embodiments of multi-colored glass substrates and methods of making the same will be described herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

In the embodiments of the glass compositions and the resultant multi-colored glass substrates described herein, the concentrations of constituent components in oxide form (e.g., SiO₂, Al₂O₃, and the like) are specified in mole percent (mol %) on an oxide basis, unless otherwise specified.

The term “0 mol %,” when used to describe the concentration and/or absence of a particular constituent component in a glass composition and the resultant multi-colored glass substrate, means that the constituent component is not present in glass composition and the resultant multi-colored glass substrate.

Fracture toughness (K_{1C}) represents the ability of a glass composition to resist fracture. Fracture toughness is measured on a non-strengthened glass substrate, such as measuring the K_{1C} value prior to ion-exchange (IOX) treatment of the glass substrate, thereby representing a feature of a glass substrate prior to IOX. The fracture toughness test methods described herein are not suitable for glasses that have been exposed to IOX treatment. But, fracture toughness measurements performed as described herein on the same glass prior to IOX treatment (e.g., glass substrates) correlate to fracture toughness after IOX treatment, and are accordingly used as such. The chevron notched short bar (CNSB) method utilized to measure the K_{1C} value is disclosed in Reddy, K. P. R. et al, “Fracture Toughness Measurement of Glass and Ceramic Materials Using Chevron-Notched Specimens,” J. Am. Ceram. Soc., 71 [6], C-310-C-313 (1988) except that Y*m is calculated using equation 5 of Bubsey, R. T. et al., “Closed-Form Expressions for Crack-Mouth Displacement and Stress Intensity Factors for Chevron-Notched Short Bar and Short Rod Specimens Based on Experimental Compliance Measurements,” NASA Technical Memorandum 83796, pp. 1-30 (October 1992). Unless otherwise specified, all fracture toughness values were measured by chevron notched short bar (CNSB) method.

Surface compressive stress is measured with a surface stress meter (FSM) such as commercially available instruments such as the FSM-6000, manufactured by Orihara Industrial Co., Ltd. (Japan). Surface stress measurements rely upon the measurement of the stress optical coefficient (SOC), which is related to the birefringence of the glass article. SOC, in turn, is measured according to Procedure C (Glass Disc Method) described in ASTM standard C770-16, entitled “Standard Test Method for Measurement of Glass Stress-Optical Coefficient,” the contents of which are incorporated herein by reference in their entirety. Depth of compression (DOC) is also measured with the FSM. The maximum central tension (CT) values are measured using a scattered light polariscope (SCALP) technique known in the art.

The term “depth of compression” (DOC), as used herein, refers to the position in the article where compressive stress transitions to tensile stress.

The term “CIELAB color space,” as used herein, refers to a color space defined by the International Commission on Illumination (CIE) in 1976. It expresses color as three values: L* for the lightness from black (0) to white (100), a* from green (−) to red (+), and B* from blue (−) to yellow (+).

The term “color gamut,” as used herein, refers to the pallet of colors that may be achieved by the multi-colored glass substrates within the CIELAB color space.

Colorants have been added to conventional aluminosilicate glass compositions and/or glass substrates have been treated to achieve multi-colored and/or patterned glass substrates having improved mechanical properties. For example, gold (Au) doped glass substrates generally appear red, orange, or purple. However, conventional methods may not produce the desired color or pattern.

Disclosed herein are methods of making multi-colored glass substrates that mitigate the aforementioned problems such that Au may be added to aluminosilicate glass compositions to produce multi-colored glass substrates having the desired color and/or pattern while retaining superior ion-exchange and drop performance. Specifically, glass substrates including Au may be irradiated and heat treated to achieve a desired color and/or pattern.

The methods described herein may be described as a combination of irradiating and subjecting a glass substrate to heat treatment to produce a multi-colored glass substrate. The colors and patterns produced are based on the radiation exposure and the heat treatment conditions.

High Energy Source

Methods of the present application are focused on generating gold nanoparticles. While not wishing to be bound by theory, the high energy sources described herein excite electrons that are captured by gold, causing the gold to nucleate and form additional gold nanoparticles.

In embodiments, the high energy source of the methods described herein may comprise an X-ray source or an ultrafast laser beam.

In embodiments, the X-ray source may have a wavelength greater than or equal to 0.01 nm and less than or equal to 10 nm. In embodiments, the X-ray source may have a wavelength greater than or equal to 0.01 nm, greater than or equal to 0.1 nm, greater than or equal to 1 nm, or even greater than or equal to 2 nm. In embodiments, the X-ray source may have a wavelength less than or equal to 10 nm, less than or equal to 7 nm, or even less than or equal to 5 nm. In embodiments, the X-ray source may have a wavelength greater than or equal to 0.01 nm and less than or equal to 10 nm, greater than or equal to 0.01 nm and less than or equal to 7 nm, greater than or equal to 0.01 nm and less than or equal to 5 nm, greater than or equal to 0.1 nm and less than or equal to 10 nm, greater than or equal to 0.1 nm and less than or equal to 7 nm, greater than or equal to 0.1 nm and less than or equal to 5 nm, greater than or equal to 1 nm and less than or equal to 10 nm, greater than or equal to 1 nm and less than or equal to 7 nm, greater than or equal to 1 nm and less than or equal to 5 nm, greater than or equal to 2 nm and less than or equal to 10 nm, greater than or equal to 2 nm and less than or equal to 7 nm, or even greater than or equal to 2 nm and less than or equal to 5 nm, or any and all sub-ranges formed from any of these endpoints.

In embodiments, the X-ray source may have a power less than or equal to 4000 W. In embodiments, the X-ray source may have a power less than or equal to 4000 W, less than or equal to 2000 W, less than or equal to 1000 W, less than or equal to 500 W, less than or equal to 100 W, or even less than or equal to 50 W. In embodiments, the X-ray source may have a power greater than or equal to 1 W, greater than or equal to 5 W, or even greater than or equal to 10 W. In embodiments, the X-ray source may have a power greater than or equal to 1 W and less than or equal to 4000 W, greater than or equal to 1 W and less than or equal to 2000 W, greater than or equal to 1 W and less than or equal to 1000 W, greater than or equal to 1 W and less than or equal to 500 W, greater than or equal to 1 W and less than or equal to 100 W, greater than or equal to 1 W and less than or equal to 50 W, greater than or equal to 5 W and less than or equal to 4000 W, greater than or equal to 5 W and less than or equal to 2000 W, greater than or equal to 5 W and less than or equal to 1000 W, greater than or equal to 5 W and less than or equal to 500 W, greater than or equal to 5 W and less than or equal to 100 W, greater than or equal to 5 W and less than or equal to 50 W, greater than or equal to 10 W and less than or equal to 4000 W, greater than or equal to 10 W and less than or equal to 2000 W, greater than or equal to 10 W and less than or equal to 1000 W, greater than or equal to 10 W and less than or equal to 500 W, greater than or equal to 10 W and less than or equal to 100 W, or even greater than or equal to 10 W and less than or equal to 50 W, or any and all sub-ranges formed from any of these endpoints.

In embodiments, the X-ray source may have a voltage less than or equal to 60 kV. In embodiments, the X-ray source may have a voltage less than or equal to 60 kV or even less than or equal to 30 kV. In embodiments, the X-ray source may have a voltage greater than or equal to 5 kV or even greater than or equal to 15 kV. In embodiments, the X-ray source may have a voltage greater than or equal to 5 kV and less than or equal to 60 kV, greater than or equal to 5 kV and less than or equal to 30 kV, greater than or equal to 15 kV and less than or equal to 60 kV, or even greater than or equal to 15 kV and less than or equal to 30 kV, or any and all sub-ranges formed from any of these endpoints.

In embodiments, the X-ray source may have a current less than or equal to 160 mA. In embodiments, the X-ray source may have a current less than or equal to 160 mA, less than or equal to 130 mA, or even less than or equal to 100 mA. In embodiments, the X-ray source may have a current greater than or equal to 10 mA, greater than or equal to 25 mA, or even greater than or equal to 50 mA. In embodiments, the X-ray source may have a current greater than or equal to 10 mA and less than or equal to 160 mA, greater than or equal to 10 mA and less than or equal to 130 mA, greater than or equal to 10 mA and less than or equal to 100 mA, greater than or equal to 25 mA and less than or equal to 160 mA, greater than or equal to 25 mA and less than or equal to 130 mA, greater than or equal to 25 mA and less than or equal to 100 mA, greater than or equal to 50 mA and less than or equal to 160 mA, greater than or equal to 50 mA and less than or equal to 130 mA, or even greater than or equal to 50 mA and less than or equal to 100 mA, or any and all sub-ranges formed from any of these endpoints.

In embodiments, the ultrafast laser beam may have a pulse width greater than or equal to 10⁻¹² s and less than or equal to 10⁻¹⁵ s. In embodiments, the ultrafast laser beam may be a femtosecond laser (i.e., a pulse width of 10⁻¹⁵ s). In embodiments, the ultrafast laser beam may be a picosecond laser (i.e., a pulse width of 10⁻¹² s). In embodiments, the ultrafast laser beam may have a pulse width greater than or equal to 10⁻¹² s or even greater than or equal to 10⁻¹³ s. In embodiments, the ultrafast laser beam may have a pulse width less than or equal to 10⁻¹⁵ s or even less than or equal to 10⁻¹⁴ s. In embodiments, the ultrafast laser beam may have a pulse width greater than or equal to 10⁻¹² s and less than or equal to 10⁻¹⁵ s, greater than or equal to 10⁻¹² s and less than or equal to 10⁻¹⁴ s, greater than or equal to 10⁻¹³ s and less than or equal to 10⁻¹⁵ s, or even greater than or equal to 10⁻¹³ s and less than or equal to 10⁻¹⁴ s, or any and all sub-ranges formed from any of these endpoints.

In embodiments, the ultrafast laser beam may have a peak intensity greater than or equal to 10¹³ W/cm². In embodiments, the ultrafast laser beam may have a peak intensity greater than or equal to 10¹³ W/cm², greater than or equal to 10¹⁴ W/cm², or even greater than or equal to 10¹⁵ W/cm². In embodiments, the ultrafast laser beam may have a peak intensity less than or equal to 10²³ W/cm², less than or equal to 10²² W/cm², less than or equal to 10²¹ W/cm², or even less than or equal to 10²⁰ W/cm². In embodiments, the ultrafast laser beam may have a peak intensity greater than or equal to 10¹³ W/cm² and less than or equal to 10²³ W/cm², greater than or equal to 10¹³ W/cm² and less than or equal to 10²² W/cm², greater than or equal to 10¹³ W/cm² and less than or equal to 10²¹ W/cm², greater than or equal to 10¹³ W/cm² and less than or equal to 10²⁰ W/cm², greater than or equal to 10¹⁴ W/cm² and less than or equal to 10²³ W/cm², greater than or equal to 10¹⁴ W/cm² and less than or equal to 10²² W/cm², greater than or equal to 10¹⁴ W/cm² and less than or equal to 10²¹ W/cm², greater than or equal to 10¹⁴ W/cm² and less than or equal to 10²⁰ W/cm², greater than or equal to 10¹⁵ W/cm² and less than or equal to 10²³ W/cm², greater than or equal to 10¹⁵ W/cm² and less than or equal to 10²² W/cm², greater than or equal to 10¹⁵ W/cm² and less than or equal to 10²¹ W/cm², or even greater than or equal to 10¹⁵ W/cm² and less than or equal to 10²⁰ W/cm², or any and all sub-ranges formed from any of these endpoints.

In embodiments, the ultrafast laser beam may have a wavelength greater than or equal to 300 nm and less than or equal to 1100 nm. In embodiments, the high energy source may be a UV source (i.e., wavelength greater than or equal to 300 nm and less than or equal to 400 nm) or an IR source (i.e., wavelength greater than or equal to 780 nm and less than or equal to 1000 nm). In embodiments, the ultrafast laser beam may have a wavelength of 343 nm. In embodiments, the ultrafast laser beam may have a wavelength of 515 nm. In embodiments, the ultrafast laser beam may have a wavelength of 800 nm. In embodiments, the ultrafast laser beam may have a wavelength of 1030 nm. In embodiments, the ultrafast laser beam may have a wavelength greater than or equal to 300 nm or even greater than or equal to 400 nm. In embodiments, the ultrafast laser beam may have a wavelength less than or equal to 1100 nm, less than or equal to 900 nm, or even less than or equal to 700 nm. In embodiments, the ultrafast laser beam may have a wavelength greater than or equal 300 nm and less than or equal to 1100 nm, greater than or equal 300 nm and less than or equal to 900 nm, greater than or equal 300 nm and less than or equal to 700 nm, greater than or equal 350 nm and less than or equal to 1100 nm, greater than or equal 350 nm and less than or equal to 900 nm, greater than or equal 350 nm and less than or equal to 700 nm, greater than or equal 400 nm and less than or equal to 1100 nm, greater than or equal 400 nm and less than or equal to 900 nm, or even greater than or equal 400 nm and less than or equal to 700 nm, or any and all sub-ranges formed from any of these endpoints.

In embodiments, the ultrafast laser beam may have a pulse energy greater than or equal to 0.5 μJ and less than or equal to 30 μJ. In embodiments, the ultrafast laser beam may have a pulse energy greater than or equal to 0.5 μJ, greater than or equal to 1 μJ, greater than or equal to 5 μJ, or even greater than or equal to 10 μJ. In embodiments, the ultrafast laser beam may have a pulse energy less than or equal to 30 μJ, less than or equal to 25 μJ, or even less than or equal to 20 μJ. In embodiments, the ultrafast laser beam may have a pulse energy greater than or equal to 0.5 μJ and less than or equal to 30 μJ, greater than or equal to 0.5 μJ and less than or equal to 25 μJ, greater than or equal to 0.5 μJ and less than or equal to 20 μJ, greater than or equal to 1 μJ and less than or equal to 30 μJ, greater than or equal to 1 μJ and less than or equal to 25 μJ, greater than or equal to 1 μJ and less than or equal to 20 μJ, greater than or equal to 5 μJ and less than or equal to 30 μJ, greater than or equal to 5 μJ and less than or equal to 25 μJ, greater than or equal to 5 μJ and less than or equal to 20 μJ, greater than or equal to 10 μJ and less than or equal to 30 μJ, greater than or equal to 10 μJ and less than or equal to 25 μJ, or even greater than or equal to 10 μJ and less than or equal to 20 μJ, or any and all sub-ranges formed from any of these endpoints.

In embodiments, the ultrafast laser beam may have a peak power greater than or equal to 0.05 MW and less than or equal to 20 MW. In embodiments, the ultrafast laser beam has a peak power greater than or equal to 0.05 MW, greater than or equal to 0.1 MW, greater than or equal to 1 MW, or even greater than or equal to 5 MW. In embodiments, the ultrafast laser beam has a peak power less than or equal to 20 MW, less than or equal to 15 MW, or even less than or equal to 10 MW. In embodiments, the ultrafast laser beam has a peak power greater than or equal to 0.05 MW and less than or equal to 20 MW, greater than or equal to 0.05 MW and less than or equal to 15 MW, greater than or equal to 0.05 MW and less than or equal to 10 MW, greater than or equal to 0.1 MW and less than or equal to 20 MW, greater than or equal to 0.1 MW and less than or equal to 15 MW, greater than or equal to 0.1 MW and less than or equal to 10 MW, greater than or equal to 1 MW and less than or equal to 20 MW, greater than or equal to 1 MW and less than or equal to 15 MW, greater than or equal to 1 MW and less than or equal to 10 MW, greater than or equal to 5 MW and less than or equal to 20 MW, greater than or equal to 5 MW and less than or equal to 15 MW, or even greater than or equal to 5 MW and less than or equal to 10 MW, or any and all sub-ranges formed from any of these endpoints.

In embodiments, the ultrafast laser beam may have a repetition rate greater than or equal to 25 kHz or even greater than or equal to 50 kHz. In embodiments, the ultrafast laser beam may have repetition rate less than or equal to 500 kHz or even less than or equal to 250 kHz. In embodiments, the ultrafast laser beam may have a repetition rate greater than or equal to 25 kHz and less than or equal to 500 kHz, greater than or equal to 25 kHz and less than or equal to 200 kHz, greater than or equal to 50 kHz and less than or equal to 500 kHz, or even greater than or equal to 50 kHz and less than or equal to 200 kHz, or any and all sub-ranges formed from any of these endpoints.

In embodiments, the ultrafast laser beam may have a focal length greater than or equal to 25 mm, greater than or equal to 50 mm, or even greater than or equal to 100 mm. In embodiments, the ultrafast laser beam may have a focal length less than or equal to 500 mm or even less than or equal to 250 mm. In embodiments, the ultrafast laser beam may have a focal length greater than or equal to 25 mm and less than or equal to 500 mm, greater than or equal to 25 mm and less than or equal to 250 mm, greater than or equal to 50 mm and less than or equal to 500 mm, greater than or equal to 50 mm and less than or equal to 250 mm, greater than or equal to 100 mm and less than or equal to 500 mm, or even greater than or equal to 100 mm and less than or equal to 250 mm, or any and all subranges formed from any of these endpoints.

In embodiments, the ultrafast laser beam may be focused or non-focused. In embodiments, the ultrafast laser beam may have a spot size greater than or equal to 10 μm or even greater than or equal to 100 μm. In embodiments, the spot size may be less than or equal to 5 mm, less than or equal to 2.5 mm, or even less than or equal to 1 mm. In embodiments, the ultrafast laser beam may have a spot size greater than or equal to 10 μm and less than or equal to 5 mm, greater than or equal to 10 μm and less than or equal to 2.5 mm, greater than or equal to 10 μm and less than or equal to 1 mm, greater than or equal to 100 μm and less than or equal to 5 mm, greater than or equal to 100 μm and less than or equal to 2.5 mm, or even greater than or equal to 100 μm and less than or equal to 1 mm, or any and all sub-ranges formed from any of these endpoints.

In embodiments, irradiating the glass substrate may be conducted for a time period greater than or equal to 0.001 hours and less than or equal to 1 hour. In embodiments, irradiating the glass substrate may be conducted for a time period greater than or equal to 0.001 hours, greater than or equal to 0.01 hours, or even greater than or equal to 0.1 hours. In embodiments, irradiated the glass substrate may be conducted for a time period less than or equal to 1 hour, less than or equal to 0.5 hours, or even less than or equal to 0.25 hours. In embodiments, irradiating the glass substrate may be conducted for a time period greater than or equal to 0.001 hours and less than or equal to 1 hour, greater than or equal to 0.001 hours and less than or equal to 0.5 hours, greater than or equal to 0.001 hours and less than or equal to 0.25 hours, greater than or equal to 0.01 hours and less than or equal to 1 hour, greater than or equal to 0.01 hours and less than or equal to 0.5 hours, greater than or equal to 0.01 hours and less than or equal to 0.25 hours, greater than or equal to 0.1 hours and less than or equal to 1 hour, greater than or equal to 0.1 hours and less than or equal to 0.5 hours, or even greater than or equal to 0.1 hours and less than or equal to 0.25 hours, or any and all sub-ranges formed from any of these endpoints.

In embodiments, a mask may be disposed between the glass substrate and the high energy source prior to irradiation. The mask provides a radiation blocking pattern, resulting in irradiated regions that are exposed to radiation. The radiation exposure time and/or intensity may be varied in different regions of the glass substrate to provide irradiated regions having different transmittance color coordinates in the CIELAB color space, as measured at an article thickness of 1.33 mm under F2 illumination and a 10° standard observer angle.

The mask may be produced by any appropriate process. In embodiments, the mask may be a steel mask. In embodiments, the mask may be produced by an ink jet printing process. The mask may be produced directly on a surface of the glass substrate or on a transparent carrier substrate, such as a glass carrier substrate. In embodiments, the mask may be completely opaque to the high energy source. In other embodiments, the mask may be partially opaque to the high energy source, and may include at least two regions with different levels of opacity to the high energy source. The different levels of opacity of the mask produce regions of the glass substrate that are exposed to different levels of radiation intensity. In embodiments, the mask may be removed after the conclusion of the irradiation, and in some embodiments, may be removed before the heat treatment of the irradiated glass substrate.

Heat Treatment

In embodiments, the heat treatment of the methods described herein, including pre-heat treatment, may comprise an isothermal heat treatment or a gradient heat treatment. While not wishing to be bound theory, the heat treatment promotes the nucleation and growth of the gold nanoparticles.

The heat treatment is characterized by the temperature of the environment (i.e., the oven) and the duration of the heat treatment (i.e., the time the glass substrate is exposed to the heated environment). As used herein, the phrase “temperature of the heat treatment” refers to the temperature of the environment (i.e., the oven). “Isothermal heat treatment” refers to heating the glass substrate in an oven having a constant temperature. “Gradient heat treatment” refers to heating the glass substrate in an oven having a varying temperature throughout the oven.

In embodiments, the heat treatment may be conducted at a temperature of greater than or equal to 500° C. to less than or equal to 900° C. and for a time period greater than or equal to 0.5 hours and less than or equal to 12 hours.

In embodiments, the heat treatment may be conducted at a temperature greater than or equal to 500° C., greater than or equal to 525° C., or even greater than or equal to 550° C. In embodiments, the heat treatment may be conducted at a temperature less than or equal to 900° C., less than or equal to 750° C., or even less than or equal to 600° C. In embodiments, the heat treatment may be conducted at a temperature greater than or equal to 500° C. to less than or equal to 900° C., greater than or equal to 500° C. to less than or equal to 750° C., greater than or equal to 500° C. to less than or equal to 600° C., greater than or equal to 525° C. to less than or equal to 900° C., greater than or equal to 525° C. to less than or equal to 750° C., greater than or equal to 525° C. to less than or equal to 600° C., greater than or equal to 550° C. to less than or equal to 900° C., greater than or equal to 550° C. to less than or equal to 750° C., or even greater than or equal to 550° C. to less than or equal to 600° C., or any and all sub-ranges formed from any of these endpoints.

In embodiments, the heat treatment may be conducted for a time period greater than or equal to 0.5 hours, greater than or equal to 1 hour, or even greater than or equal to 2 hours. In embodiments, the heat treatment may be conducted for a time period less than or equal to 12 hours, less than or equal to 8 hours, or even less than or equal to 4 hours. In embodiments, the heat treatment may be conducted for a time period greater than or equal to 0.5 hours and less than or equal to 12 hours, greater than or equal to 0.5 hours and less than or equal to 8 hours, greater than or equal to 0.5 hours and less than or equal to 4 hours, greater than or equal to 1 hour and less than or equal to 12 hours, greater than or equal to 1 hour and less than or equal to 8 hours, greater than or equal to 1 hour and less than or equal to 4 hours, greater than or equal to 2 hours and less than or equal to 12 hours, greater than or equal to 2 hours and less than or equal to 8 hours, or even greater than or equal to 2 hours and less than or equal to 4 hours, or any and all sub-ranges formed from any of these endpoints.

Method A—Irradiation and Subsequent Heat Treatment

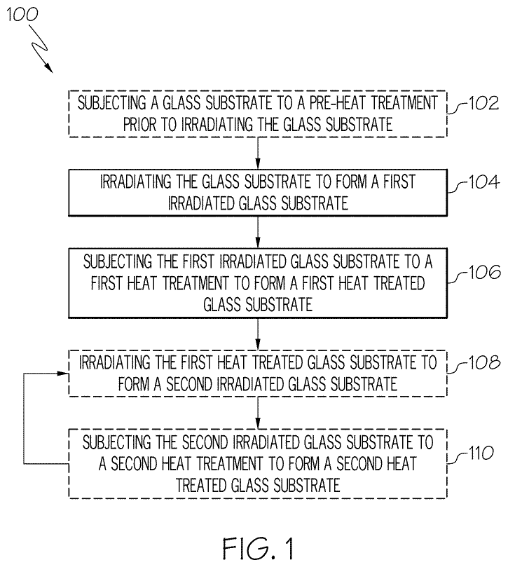

Referring now to FIG. 1, a method of forming a multi-colored glass substrate according to embodiments described herein is shown at 100. The method 100 may optionally begin at block 102 with subjecting a glass substrate 200 to a pre-heat treatment prior to irradiating the glass substrate 200. For example, in embodiments, the pre-heat treatment may comprise a gradient heat treatment as described hereinabove.

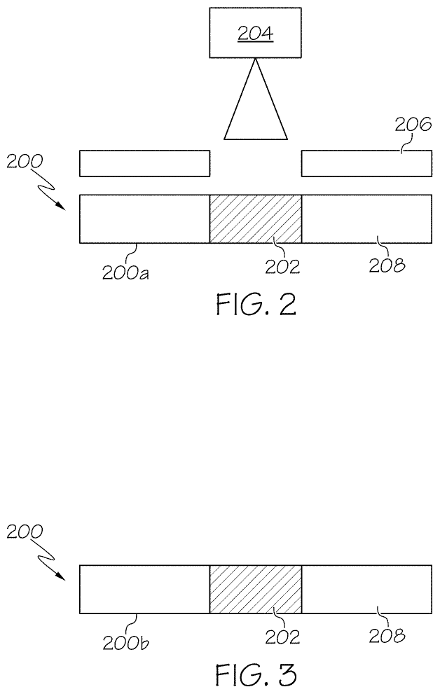

Referring back to FIG. 1 and FIG. 2, the method 100 begins or continues at block 104 with irradiating a first region 202 of the glass substrate 200 with a first high energy source 204 to form a first irradiated glass substrate 200a. For example, in embodiments, the first high energy source 204 may comprise an X-ray source or an ultrafast laser beam as described hereinabove.

In embodiments, a first mask 206 may be disposed between the glass substrate 200 and the first high energy source 204 prior to irradiating the glass substrate 200 to form the second region 208. The first mask 206 is opaque to the first high energy source 204 and may function and be produced as described hereinabove. In embodiments, the first mask 206 is removed after irradiating the glass substrate 200.

Referring back to FIG. 1 and to FIG. 3, the method 100 continues at block 106 with subjecting the first irradiated glass substrate 200a to a first heat treatment to form a first heat treated glass substrate 200b. In embodiments, the first heat treatment may comprise an isothermal heat treatment or a gradient heat treatment as described hereinabove. As described in further detail below, the second region 208 of the first heat treated glass substrate 200b may have a different transmittance color coordinate in the CIELAB color space, as measured at an article thickness of 1.33 mm under F2 illumination and a 10° standard observer angle, than the first region 202.

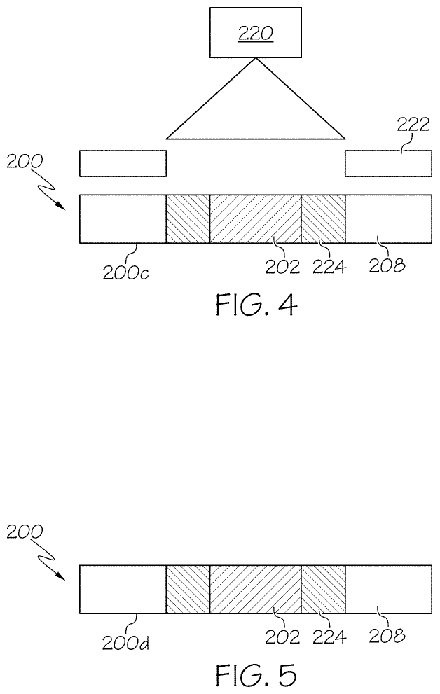

Referring back to FIG. 1 and now to FIG. 4, the method 100 may optionally continue at block 108 with irradiating the first heat treated glass substrate 200b with a second high energy source 220 to form a second irradiated glass substrate 200c. For example, in embodiments, the second high energy source 220 may comprise an X-ray source or an ultrafast laser beam as described hereinabove. In embodiments, the second high energy source 220 may include the same or different parameters as the first high energy source 204.

In embodiments, a second mask 222 may be disposed between the first heat treated glass substrate 200b and the second high energy source 220 prior to irradiating the first heat treated glass substrate 200b to form the third region 224. The second mask 222 is opaque to the second high energy source 220 and may function and be produced as described hereinabove. In embodiments, the second mask 222 is removed after irradiating the first heat treated glass substrate 200b. As described in further detail below, in embodiments, the third region 224 having a different transmittance color coordinate in the CIELAB color space, as measured at an article thickness of 1.33 mm under F2 illumination and a 10° standard observer angle, than at least one of the first region 202 and the second region 208.

Referring back to FIG. 1 and to FIG. 5, the method 100 may optionally continue at block 110 with subjecting the second irradiated glass substrate 200c to a second heat treatment to form a second heat treated glass substrate 200d. In embodiments, the second heat treatment may comprise an isothermal heat treatment or a gradient heat treatment as described hereinabove. In embodiments, the second heat treatment may include the same or different parameters as the first heat treatment.

In embodiments, the step of block 108 and/or the step of block 110 of method 100 may optionally be repeated until the desired color and/or pattern is achieved. In embodiments, additional high energy sources (e.g., third high energy source, fourth high energy source, etc.) used in the repetition of block 108 may include the same or different parameters as the first or second high energy sources. In embodiments, additional masks (e.g., third mask, fourth mask, etc.) may be used in the repetition of block 108 to form additional regions of the glass substrate 200. In embodiments, additional heat treatments (e.g., third heat treatment, fourth heat treatment, etc.) used in the repetition of block 110 may include the same or different parameters as the first or second heat treatments.

Method B—Heat Treatment and Subsequent Irradiation

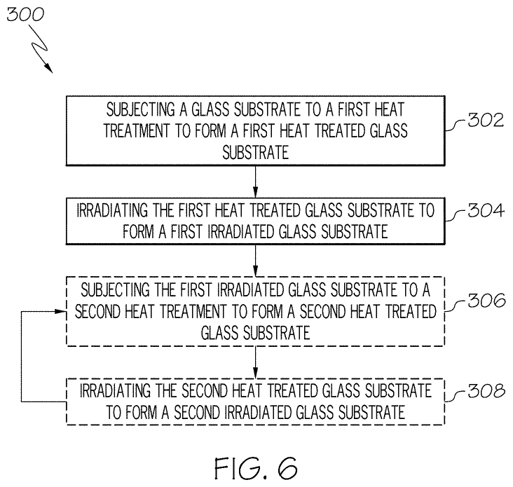

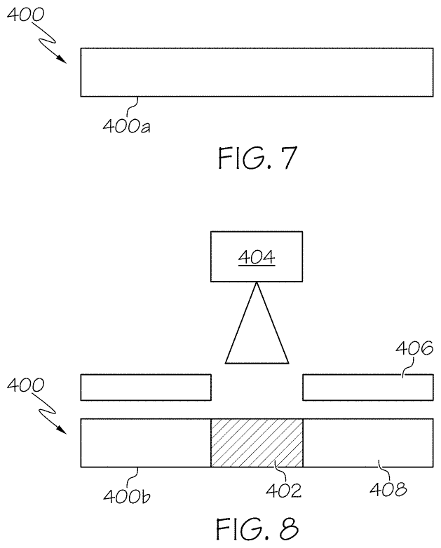

Referring now to FIG. 6, another method of forming a multi-colored glass substrate is shown at 300. Referring now to FIG. 6 and FIG. 7, the method 300 begins at block 302 with subjecting a glass substrate 400 to a first heat treatment to form a first heat treated glass substrate 400a. In embodiments, the first heat treatment may comprise an isothermal heat treatment or a gradient heat treatment as described hereinabove.

Referring back to FIG. 6 and to FIG. 8, the method 300 continues at block 304 with irradiating a first region 402 of the first heat treated glass substrate 400a with a first high energy source 404 to form a first irradiated glass substrate 400b. For example, in embodiments, the first high energy source 404 may comprise an X-ray source or an ultrafast laser beam as described hereinabove. As described in further detail below, the first irradiated glass substrate 400b may comprise a second region 408 having a different transmittance color coordinate in the CIELAB color space, as measured at an article thickness of 1.33 mm under F2 illumination and a 10° standard observer angle, than the first region 402.

In embodiments, a first mask 406 may be disposed between the first heat treated glass substrate 400a and the first high energy source 404 prior to irradiating the first heat treated glass substrate 400a to form the second region 408. The first mask 406 is opaque to the first high energy source 404 and may function and be produced as described hereinabove. In embodiments, the first mask 406 is removed after irradiating the first heat treated glass substrate 400a.

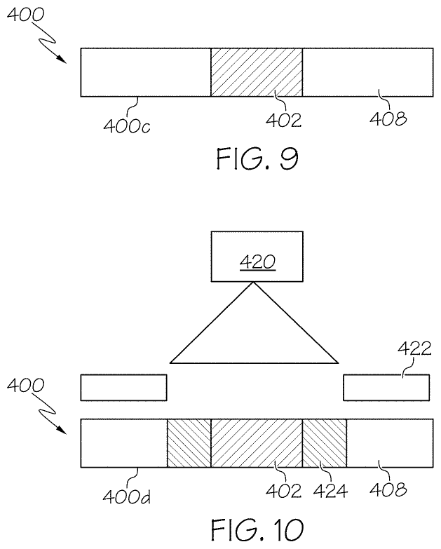

Referring back to FIG. 6 and to FIG. 9, the method 300 may optionally continue at block 306 with subjecting the first irradiated glass substrate 400b to a second heat treatment to form a second heat treated glass substrate 400c. In embodiments, the second heat treatment may comprise an isothermal heat treatment as described hereinabove.

Referring back to FIG. 6 and now to FIG. 10, the method 300 may optionally continue at block 308 with irradiating the second heat treated glass substrate 400c with a second high energy source 420 to form a second irradiated glass substrate 400d. For example, in embodiments, the second high energy source 420 may comprise an X-ray source or an ultrafast laser beam as described hereinabove. In embodiments, the second high energy source 420 may include the same or different parameters as the first high energy source 404.

In embodiments, a second mask 422 may be disposed between the second heat treated glass substrate 400c and the second high energy source 420 prior to irradiating the second heat treated glass substrate 400c to form the third region 424. The second mask 422 is opaque to the second high energy source 420 and may function and be produced as described hereinabove. In embodiments, the second mask 422 is removed after irradiating the second heat treated glass substrate 400c. As described in further detail below, in embodiments, the third region 424 having a different transmittance color coordinate in the CIELAB color space, as measured at an article thickness of 1.33 mm under F2 illumination and a 10° standard observer angle, than at least one of the first region 402 and the second region 408.

In embodiments, the step of block 306 and/or the step of block 308 of method 300 may optionally be repeated until the desired color and/or pattern is achieved. In embodiments, additional heat treatments (e.g., third heat treatment, fourth heat treatment, etc.) used in the repetition of block 306 may include the same or different parameters as the first or second heat treatments. In embodiments, additional high energy sources (e.g., third high energy source, fourth high energy source, etc.) used in the repetition of block 308 may include the same or different parameters as the first or second high energy sources. In embodiments, additional masks (e.g., third mask, fourth mask, etc.) may be used in the repetition of block 308 to form additional regions of the glass substrate 400.

Glass Substrate

In embodiments, the glass substrate may comprise Au. In embodiments, the glass substrate may comprise a glass or a glass-ceramic. By way of non-limiting examples, the glass substrate may comprise borate glass, silicoborate glass, phosphate-based glass, silicon carbide glass, soda-lime silicate glass, aluminosilicate glass, alkali-aluminosilicate glass, borosilicate glass, alkali-borosilicate glass, aluminoborosilicate glass, alkali-alumino-borosilicate glass, or alkali-aluminosilicate glass.

In embodiments, the glass substrate may comprise Au. In embodiments, the glass substrate may comprise greater than or equal to 50 mol % and less than or equal to 70 mol % SiO₂; greater than or equal to 5 mol % and less than or equal to 25 mol % Al₂O₃; greater than or equal to 0 mol % and less than or equal to 15 mol % B₂O₃; greater than or equal to 1 mol % and less than or equal to 20 mol % Li₂O; greater than or equal to 0 mol % and less than or equal to 15 mol % Na₂O; greater than or equal to 0 mol % and less than or equal to 3 mol % K₂O; greater than or equal to 0 mol % and less than or equal to 3 mol % MgO; greater than or equal to 0 mol % and less than or equal to 3 mol % ZnO; greater than or equal to 0 mol % and less than or equal to 3 mol % ZrO₂; greater than or equal to 0 mol % and less than or equal to 1 mol % SnO₂; greater than or equal to 0 mol % and less than or equal to 1 mol % Fe₂O₃; and greater than or equal to 0.00001 mol % and less than or equal to 0.01 mol % Au.

The multi-colored glass substrates may be any suitable thickness, which may vary depending on the particular application of the multi-colored glass substrate. In embodiments, the multi-colored glass substrates may have a thickness greater than or equal to 250 μm and less than or equal to 6 mm, greater than or equal to 250 μm and less than or equal to 4 mm, greater than or equal to 250 μm and less than or equal to 2 mm, greater than or equal to 250 μm and less than or equal to 1 mm, greater than or equal to 250 μm and less than or equal to 750 μm, greater than or equal to 250 μm and less than or equal to 500 μm, greater than or equal to 500 μm and less than or equal to 6 mm, greater than or equal to 500 μm and less than or equal to 4 mm, greater than or equal to 500 μm and less than or equal to 2 mm, greater than or equal to 500 μm and less than or equal to 1 mm, greater than or equal to 500 μm and less than or equal to 750 μm, greater than or equal to 750 μm and less than or equal to 6 mm, greater than or equal to 750 μm and less than or equal to 4 mm, greater than or equal to 750 μm and less than or equal to 2 mm, greater than or equal to 750 μm and less than or equal to 1 mm, greater than or equal to 1 mm and less than or equal to 6 mm, greater than or equal to 1 mm and less than or equal to 4 mm, greater than or equal to 1 mm and less than or equal to 2 mm, greater than or equal to 2 mm and less than or equal to 6 mm, greater than or equal to 2 mm and less than or equal to 4 mm, or even greater than or equal to 4 mm and less than or equal to 6 mm, or any and all sub-ranges formed from any of these endpoints.

As mentioned hereinabove, in embodiments, a glass substrate treated in accordance with the methods described herein may comprise regions having different transmittance color coordinates in the CIELAB color space, as measured at an article thickness of 1.33 mm under F2 illumination and a 10° standard observer angle than other regions. In embodiments, a region of the multi-colored glass substrate may have a transmittance color coordinate in the CIELAB color space, as measured at an article thickness of 1.33 mm under F2 illumination and a 10° standard observer angle, of: L* greater than or equal to 50 and less than or equal to 100; a* greater than or equal to −8 and less than or equal to 26; and b* greater than or equal to −28 and less than or equal to 15. The observable colors exhibited by the multi-colored glass substrate may include oranges, pinks, blues, magentas, greens, and reds. In embodiments, the multi-colored glass substrate may exhibit one of more colors together with a colorless (i.e., clear) region.

As discussed hereinabove, multi-colored glass substrates described herein may have an increased fracture toughness such that the multi-colored glass substrates are more resistant to damage. In embodiments, the multi-colored glass substrates may have a K_{Ic} fracture toughness, as measured by a CNSB method prior to ion-exchange, greater than or equal to 0.7 MPa·m^{1/2}. In embodiments, the multi-colored glass substrate may have a K_{Ic} fracture toughness, prior to ion-exchange, as measured by a CNSB method greater than or equal to 0.7 MPa·m^{1/2}, greater than or equal to 0.8 MPa·m^{1/2}, greater than or equal to 0.9 MPa·m^{1/2}, or even greater than or equal to 1.0 MPa·m^{1/2}.

Ion-Exchange

In embodiments, the multi-colored glass substrates described herein are ion-exchangeable to facilitate strengthening the multi-colored glass substrates. In typical ion-exchange processes, smaller metal ions in the glass substrate are replaced or “exchanged” with larger metal ions of the same valence within a layer that is close to the outer surface of the multi-colored glass substrate. The replacement of smaller ions with larger ions creates a compressive stress within the layer of the multi-colored glass substrate. In embodiments, the metal ions are monovalent metal ions (e.g., Li⁺, Na⁺, K⁺, and the like), and ion-exchange is accomplished by immersing the glass substrate in a bath comprising at least one molten salt of the larger metal ion that is to replace the smaller metal ion in the multi-colored glass substrate. Alternatively, other monovalent ions such as Ag⁺, Tl⁺, Cu⁺, and the like may be exchanged for monovalent ions. The ion-exchange process or processes that are used to strengthen the multi-colored glass substrate may include contacting the multi-colored glass substrate with an ion-exchange medium. In embodiments, the ion-exchange medium may be a molten salt bath. For example, the ion-exchange process may include, but is not limited to, immersion in a single bath or multiple baths of like or different compositions with optional washing and/or annealing steps between immersions.

Upon exposure to the multi-colored glass substrate, the ion-exchange solution (e.g., KNO₃ and/or NaNO₃ molten salt bath) may, according to embodiments, be at a temperature greater than or equal to 350° C. and less than or equal to 500° C., greater than or equal to 360° C. and less than or equal to 450° C., greater than or equal to 370° C. and less than or equal to 440° C., greater than or equal to 360° C. and less than or equal to 420° C., greater than or equal to 370° C. and less than or equal to 400° C., greater than or equal to 375° C. and less than or equal to 475° C., greater than or equal to 400° C. and less than or equal to 500° C., greater than or equal to 410° C. and less than or equal to 490° C., greater than or equal to 420° C. and less than or equal to 480° C., greater than or equal to 430° C. and less than or equal to 470° C., or even greater than or equal to 440° C. and less than or equal to 460° C., or any and all sub-ranges between the foregoing values. In embodiments, the multi-colored glass substrate may be exposed to the ion-exchange solution for a duration greater than or equal to 2 hours and less than or equal to 24 hours, greater than or equal to 2 hours and less than or equal to 12 hours, greater than or equal to 2 hours and less than or equal to 6 hours, greater than or equal to 8 hours and less than or equal to 24 hours, greater than or equal to 6 hours and less than or equal to 24 hours, greater than or equal to 6 hours and less than or equal to 12 hours, greater than or equal to 8 hours and less than or equal to 24 hours, or even greater than or equal to 8 hours and less than or equal to 12 hours, or any and all sub-ranges formed from any of these endpoints.

In embodiments, a multi-colored glass substrate may be ion-exchanged to achieve a depth of compression greater than or equal to 10 μm, greater than or equal to 20 μm, greater than or equal to 30 μm, greater than or equal to 40 μm, greater than or equal to 50 μm, greater than or equal to 60 μm, greater than or equal to 70 μm, greater than or equal to 80 μm, greater than or equal to 90 μm or greater, or greater than or equal to 100 μm. In embodiments, the multi-colored glass substrate may have a thickness “t” and may be ion-exchanged to achieve a depth of compression greater than or equal to 0.15t, greater than or equal to 0.17t, or even greater than or equal to 0.2t. In embodiments, the multi-colored glass substrate may have a thickness “t” and may be ion-exchanged to achieve a depth of compression less than or equal to 0.3t, less than or equal to 0.27t, or even less than or equal to 0.25t. In embodiments, the multi-colored glass substrate may have a thickness “t” and may be ion-exchanged to achieve a depth of compression greater than or equal to 0.15t and less than or equal to 0.3t, greater than or equal to 0.15t and less than or equal to 0.27t, greater than or equal to 0.15t and less than or equal to 0.25t, greater than or equal to 0.17t and less than or equal to 0.3t, greater than or equal to 0.17t and less than or equal to 0.27t, greater than or equal to 0.17t and less than or equal to 0.25t, greater than or equal to 0.2t and less than or equal to 0.3t, greater than or equal to 0.2t and less than or equal to 0.27t, or even greater than or equal to 0.2t and less than or equal to 0.25t, or any and all sub-ranges formed from any of these endpoints.

The development of this surface compression layer is beneficial for achieving a better crack resistance and higher flexural strength compared to non-ion-exchanged materials. The surface compression layer has a higher concentration of the ions exchanged into the multi-colored glass substrate in comparison to the concentration of the ions exchanged into the multi-colored glass substrate for the body (i.e., the area not including the surface compression) of the multi-colored glass substrate. In embodiments, the multi-colored glass substrate may have a surface compressive stress after ion-exchange strengthening greater than or equal to 300 MPa, greater than or equal to 400 MPa, greater than or equal to 500 MPa, or even greater than or equal to 600 MPa. In embodiments, the multi-colored glass substrate may have a surface compressive stress after ion-exchange strengthening less than or equal to 1 GPa, less than or equal to 900 MPa, or even less than or equal to 800 MPa. In embodiments, the multi-colored glass substrate made from the glass composition may have a surface compressive stress after ion-exchange strengthening greater than or equal to 300 MPa and less than or equal to 1 GPa, greater than or equal to 300 MPa and less than or equal to 900 MPa, greater than or equal to 300 MPa and less than or equal to 800 MPa, greater than or equal to 400 MPa and less than or equal to 1 GPa, greater than or equal to 400 MPa and less than or equal to 900 MPa, greater than or equal to 400 MPa and less than or equal to 800 MPa, greater than or equal to 500 MPa and less than or equal to 1 GPa, greater than or equal to 500 MPa and less than or equal to 900 MPa, greater than or equal to 500 MPa and less than or equal to 800 MPa, greater than or equal to 600 MPa and less than or equal to 1 GPa, greater than or equal to 600 MPa and less than or equal to 900 MPa, greater than or equal to 600 MPa and less than or equal to 800 MPa.

In embodiments, the multi-colored glass substrate may have a maximum central tension after ion-exchange strengthening greater than or equal to 40 MPa, greater than or equal to 60 MPa, greater than or equal to 80 MPa, or even greater than or equal to 100 MPa. In embodiments, the multi-colored glass substrate may have a maximum central tension after ion-exchange strengthening less than or equal to 250 MPa, less than or equal to 200 MPa, or even less than or equal to 150 MPa. In embodiments, the multi-colored glass substrate may have a maximum central tension after ion-exchange strengthening greater than or equal to 40 MPa and less than or equal to 250 MPa, greater than or equal to 40 MPa and less than or equal to 200 MPa, greater than or equal to 40 MPa and less than or equal to 150 MPa, greater than or equal to 60 MPa and less than or equal to 250 MPa, greater than or equal to 60 MPa and less than or equal to 200 MPa, greater than or equal to 60 MPa and less than or equal to 150 MPa, greater than or equal to 80 MPa and less than or equal to 250 MPa, greater than or equal to 80 MPa and less than or equal to 200 MPa, greater than or equal to 80 MPa and less than or equal to 150 MPa, greater than or equal to 100 MPa and less than or equal to 250 MPa, greater than or equal to 100 MPa and less than or equal to 200 MPa, or even greater than or equal to 100 MPa and less than or equal to 150 MPa, or any and all sub-ranges formed from any of these endpoints. As utilized herein, central tension refers to a maximum central tension value unless otherwise indicated.

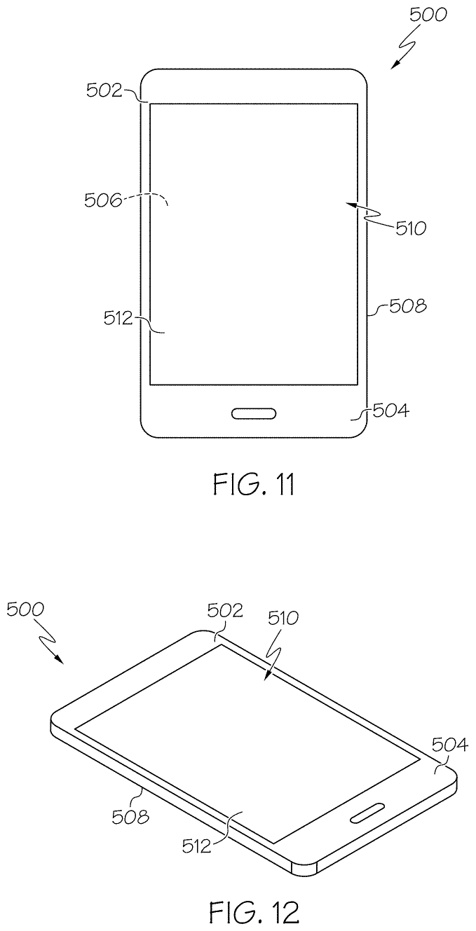

The multi-colored colored glass substrates described herein may be used for a variety of applications including, for example, back cover applications in consumer or commercial electronic devices such as smartphones, tablet computers, personal computers, ultrabooks, televisions, and cameras. An exemplary article incorporating any of the multi-colored glass substrates disclosed herein is shown in FIGS. 11 and 12. Specifically, FIGS. 11 and 12 show a consumer electronic device 500 including a housing 502 having front 504, back 506, and side surfaces 508; electrical components (not shown) that are at least partially inside or entirely within the housing and including at least a controller, a memory, and a display 510 at or adjacent to the front surface of the housing; and a cover substrate 512 at or over the front surface of the housing such that it is over the display. In embodiments, at least a portion of housing 502, such as the back 506, may include any of the multi-colored glass substrates disclosed herein.

### EXAMPLES

In order that various embodiments be more readily understood, reference is made to the following examples, which illustrate various embodiments of the multi-colored glass substrates described herein.

Table 1 shows example composition C1, with the concentration (in terms of mol %) of the example glass composition.

TABLE 1

| Composition | C1 |
|---|---|
| SiO₂ | 62.27 |
| Al₂O₃ | 14.97 |
| B₂O₃ | 5.98 |
| Li₂O | 10.45 |
| Na₂O | 4.30 |
| K₂O | 0.14 |
| MgO | 0.50 |
| ZnO | 1.00 |
| ZrO₂ | 0.29 |
| SnO₂ | 0.04 |
| Fe₂O₃ | 0.04 |
| Au | 0.0009 |

Table 2 shows the isothermal heat treatment conditions of glass articles having a thickness of 500 μm and made from example composition C1 used to produce example samples S1-S10. Table 2 also includes the absorbance peaks and color measurements of resulting example samples S1-S10.

TABLE 2

| Sample | S1 | S2 | S3 | S4 | S5 | S6 |
|---|---|---|---|---|---|---|
| Temperature | 545 | 560 | 575 | 600 | 625 | 545 |
| (° C.) | | | | | | |
| Time (hrs.) | 2 | 2 | 2 | 2 | 2 | 8 |
| Absorbance | 536 | 544 | 568 | 566 | 584 | 578 |
| peak (nm) | | | | | | |
| L* | 94.24 | 88.79 | 88.66 | 89.62 | 90.47 | 90.66 |
| a* | 2.51 | 2.78 | −0.06 | −1.11 | −0.09 | 4.64 |
| b* | −0.34 | −5.11 | −5.30 | −4.07 | −2.76 | −2.13 |

| Sample | S7 | S8 | S9 | S10 |
|---|---|---|---|---|
| Temperature | 560 | 575 | 600 | 625 |
| (° C.) | | | | |
| Time (hrs.) | 8 | 8 | 8 | 8 |
| Absorbance | 600 | 566 | 578 | 566 |
| peak (nm) | | | | |
| L* | 89.22 | 89.29 | 89.24 | 90.08 |
| a* | 2.33 | 0.98 | 1.02 | 0.27 |
| b* | −4.45 | −4.70 | −4.67 | −3.54 |

### Example Articles A1-A24: Irradiation and Subsequent Isothermal Heat Treatment

### Articles A1-A8

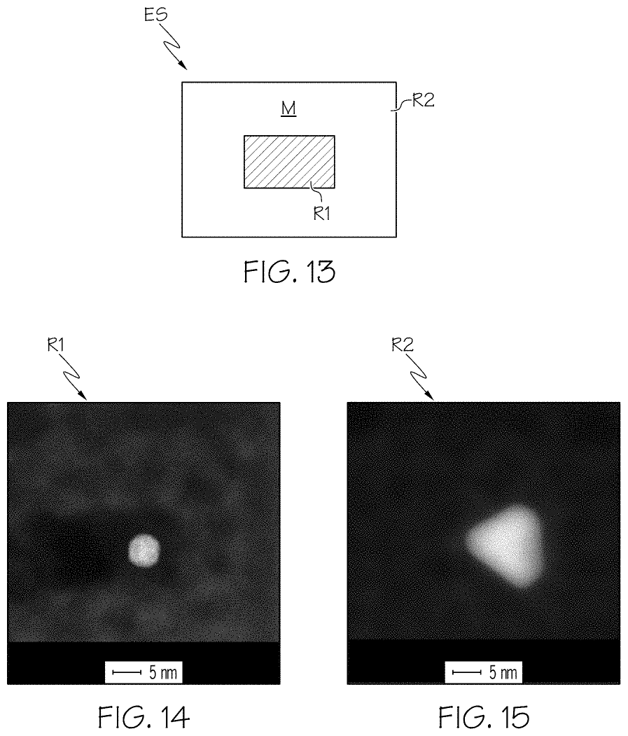

Referring now to FIG. 13 and Table 3, example samples ES as indicated in Table 3 were partially covered with a mask M such that the example samples ES had a first region R1 and a second region R2. The first region R1 was irradiated with an X-ray source (Malvern Panalytical Axios Max spectrometer with 4 kW Rh metal-ceramic end window X-ray tube in a vacuum with the spinner on) for the time indicated in Table 3. The voltage was 60 kv and the current was 50 mA.

After the irradiation, the mask M was removed and the example samples ES were subjected to an isothermal heat treatment as indicated in Table 3 to produce example articles A1-A8. The color measurements or the observable colors of the first region R1 and the second region R2 of example articles A1-A8 are listed in Table 3.

TABLE 3

| Article | | A1 | A2 | A3 | A4 |
|---|---|---|---|---|---|
| Example sample | | E1 | E1 | E1 | E2 |
| Irradiation time | | 14 sec. | 1 min. | 15 min. | 15 min. |
| Isothermal heat | | 575° C. | 575° C. | 575° C. | 545° C. |
| treatment | | for 2 hrs. | for 2 hrs. | for 2 hrs. | for 2 hrs. |
| R1 color | | L* = 92.36 | L* = 93.94 | clear | clear |
| | | a* = 2.03 | a* = 1.88 | | |
| | | b* = −0.38 | b* = 2.51 | | |
| R2 color | L* | 89.66 | 90.38 | 88.66 | 94.24 |
| | a* | −0.65 | 0.48 | −0.06 | 2.51 |
| | b* | 4.07 | −3.97 | −5.30 | −0.34 |

| Article | | A5 | A6 | A7 | A8 |
|---|---|---|---|---|---|
| Example sample | | E2 | E2 | E2 | E2 |
| Irradiation time | | 15 min. | 5 min. | 10 min. | 15 min. |
| Isothermal heat | | 575° C. | 575° C. | 575° C. | 575° C. |
| treatment | | for 2 hrs. | for 8 hrs. | for 8 hrs. | for 8 hrs. |
| R1 color | | clear | clear | clear | clear |
| R2 color | L* | 88.66 | 89.29 | 89.29 | 89.29 |
| | a* | −0.06 | 0.98 | 0.98 | .98 |
| | b* | −5.30 | −4.70 | −4.70 | −4.70 |

Referring now to FIGS. 14 and 15, transmission electron microscopy (TEM) was used to observe the precipitation and of Au nanoparticles of example article A4. The high angle annular dark field (HAADF) images shown in FIGS. 14 and 15 were obtained using an aberration corrected FEI Titan G2 scanning transmission electron microscope (STEM) operated at 200 kV. The TEM specimens were prepared by a FEI Quanta 3D 600 FEG dual beam FIB-SEM system equipped with Ga ion source operating in the accelerating-voltage range from 0.5-30 kV. TEM specimens were lifted out from the glass surface by the in-situ lift-out technique and first thinned to electron transparency at 30 keV. The final thinning processes were conducted at 5 keV and 77 pA followed by a cleaning step at 2 keV and 48 pA. A TEM lamella only represents a small area from the sample and each TEM image only records an area from the lamella. Assuming the particle distribution of the TEM recorded area may represent the particle distribution in general, then the population of Au nanoparticles per μm² may be estimated to compare between the first region R1 and the second region R2.

As shown in FIGS. 14 and 15, after being subjected to a heat treatment at 545° C. for 2 hrs., the population of Au nanoparticles precipitated out in the first region R1 was about 7 to 9 times more than that in the second region R2 in an area of 4.25 μm×4.25 μm. The morphology of Au nanoparticles in the first region R1 was spherical and cubical, while the morphology of Au nanoparticles in the second region R2 varied, including spherical, cubical, diamond-shaped, and pyramid-shaped. The particle size in the first region R1 (5.0±0.8 nm) was much smaller than the particle size in the second region R2 (11.2±2.2 nm). The size distribution of Au nanoparticles in the first region R1 was much narrower than that of the second region R2. As indicated by FIGS. 14 and 15, irradiation with an X-ray source promoted uniform growth of the Au nanoparticles.

### Articles A9-A12

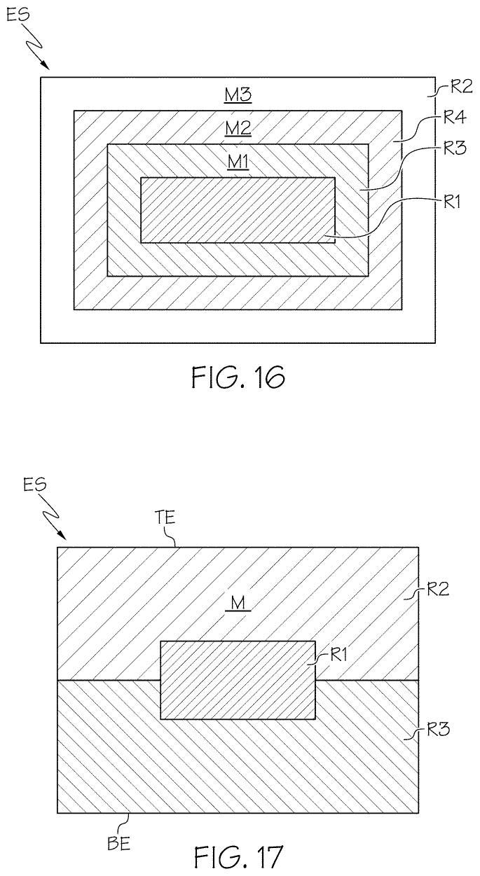

Referring now to FIG. 16 and Table 4, example samples ES as indicated in Table 4 were partially covered with a first mask M1 such that example samples ES had a first region R1 and a second region R2. The first region R1 was irradiated with a first X-ray source for the time indicated in Table 4. The first X-ray source was the same X-ray source as described above with respect to example articles A1-A8.

After the first irradiation, the first mask M1 was removed and the example samples ES were subjected to a first isothermal heat treatment as indicated in Table 4.

After the first isothermal heat treatment, the example samples ES were partially covered with a second mask M2 such that the example samples ES had a third region R3. The first region R1 and the third region R3 were irradiated with a second X-ray source for the time indicated in Table 4. The second X-ray source was the same X-ray source as described above with respect to example articles A1-A8.

After the second irradiation, the second mask M2 was removed and the example samples ES were subjected to a second isothermal heat treatment as indicated in Table 4 to produce example articles A9-A11. The color measurements of the first region R1, the second region R2, and the third region R3 of example articles A9-A11 are listed in Table 4.

After the second isothermal heat treatment, an example sample ES was partially covered with a third mask M3 such that the example sample ES had a fourth region R4. The first region R1, the third region R3, and the fourth region R4 were irradiated with a third X-ray source for the time indicated in Table 4. The third X-ray source was the same X-ray source as described above with respect to example articles A1-A8.

After the third irradiation, the third mask M3 was removed and the example sample ES was subjected to a third isothermal heat treatment as indicated in Table 4 to produce example article A12. The color measurements of the first region R1, the second region R2, and the third region R3 and the observable color of the fourth region R4 of example article A12 are listed in Table 4. Note that color measurements of the fourth region R4 were not measured because of the negligible observable color difference between the fourth region R4 and the third region R3.

TABLE 4

| Article | | A9 | A10 | A11 | A12 |
|---|---|---|---|---|---|
| Example sample | | E3 | E7 | E8 | E3 |
| First irradiation | | 15 min. | 15 min. | 15 min. | 15 min. |
| time | | | | | |
| First isothermal | | 545° C. | 575° C. | 575° C. | 545° C. |
| heat treatment | | for | for | for | for |
| | | 2 hrs. | 2 hrs. | 8 hrs. | 2 hrs. |
| Second irradiation | | 15 min. | 15 min. | 15 min. | 15 min. |
| time | | | | | |
| Second isothermal | | 575° C. | 545° C. | 545° C. | 575° C. |
| heat treatment | | for | for | for | for |
| | | 2 hrs. | 2 hrs. | 2 hrs. | 2 hrs. |
| Third irradiation | | — | — | — | 15 min. |
| time | | | | | |
| Third isothermal | | — | — | — | 575° C. |
| heat treatment | | | | | for |
| | | | | | 8 hrs. |
| R1 color | L* | 94.31 | 94.06 | 93.82 | 94.02 |
| | a* | 1.74 | 1.95 | 2.25 | 1.99 |
| | b* | 3.08 | 3.43 | 3.19 | 3.06 |
| R2 color | L* | 90.84 | 89.91 | 90.17 | 92.08 |
| | a* | 2.45 | −0.33 | 1.07 | 3.47 |
| | b* | −2.53 | −4.24 | −3.77 | −0.37 |
| R3 color | L* | 93.23 | 91.55 | 91.73 | 93.17 |
| | a* | 3.31 | 4.54 | 4.48 | 3.41 |
| | b* | 1.27 | −1.05 | −0.69 | 1.47 |

| | | | | |
|---|---|---|---|---|
| R4 color | — | — | — | pink |

### Articles A13-A24

Referring now to Table 5, a portion of example samples indicated in Table 5 were irradiated with a UV source or an IR source as indicated in Table 5 such that the example samples had a first region R1 (i.e., irradiated portion) and a second region R2 (i.e., non-irradiated portion). Table 6 lists further parameters of the UV source and the IR source. After the irradiation, the example samples were subjected to an isothermal heat treatment as indicated in Table 5 to produce example articles A13-A24. The observable colors of or damage to the first region R1 and the color measurements of the second region R2 of the example articles A13-A24 are listed in Table 5.

TABLE 5

| Article | | A13 | A14 | A15 | A16 | A17 | A18 |
|---|---|---|---|---|---|---|---|
| Example sample | | E9 | E9 | E9 | E9 | E9 | E9 |
| Irradiation | | UV at 8 W | UV at 8 W | UV at 10 W | IR at 2 W | IR at 1.5 W | IR at 1 W |
| | | for 1 min. | for 5 min. | for 1 min. | | | |
| Isothermal heat | | 545° C. | 545° C. | 545° C. | 545° C. | 545° C. | 545° C. |
| treatment | | for 2 hrs. | for 2 hrs. | for 2 hrs. | for 2 hrs. | for 2 hrs. | for 2 hrs. |
| R1 color | | negligible | negligible | negligible | color | color | negligible |
| | | observable | observable | observable | lighter than | lighter than | observable |
| | | difference | difference | difference | color of R2 | color of R2 | difference |
| | | with R2 | with R2 | with R2 | | | with R2 |
| R2 color | L* | 94.24 | 94.24 | 94.24 | 94.24 | 94.24 | 94.24 |
| | a* | 2.51 | 2.51 | 2.51 | 2.51 | 2.51 | 2.51 |
| | b* | −0.34 | −0.34 | −0.34 | −0.34 | −0.34 | −0.34 |
| Article | | A19 | A20 | A21 | A22 | A23 | A24 |
| Example sample | | E9 | E9 | E9 | E9 | E9 | E9 |
| Irradiation | | IR with | IR with | IR with | IR at 2 W | IR at 2.5 W | IR at 3 W |
| | | varied duty | varied duty | varied duty | | | |
| | | cycle at | cycle IR at | cycle IR at | | | |
| | | 70% of 4 W | 50% of 4 W | 30% of 4 W | | | |
| Isothermal heat | | 545° C. | 545° C. | 545° C. | 545° C. | 545° C. | 545° C. |
| treatment | | for 2 hrs. | for 2 hrs. | for 2 hrs. | for 2 hrs. | for 2 hrs. | for 2 hrs. |
| R1 color | | resulting | resulting | resulting | color | resulting | resulting |
| | | surface | surface | surface | lighter than | surface | surface |
| | | damage | damage | damage | color of R2 | damage | damage |
| R2 color | L* | 94.24 | 94.24 | 94.24 | 94.24 | 94.24 | 94.24 |
| | a* | 2.51 | 2.51 | 2.51 | 2.51 | 2.51 | 2.51 |
| | b* | −0.34 | −0.34 | −0.34 | −0.34 | −0.34 | −0.34 |

TABLE 6

| | UV Source | | IR Source | |
|---|---|---|---|---|
| Wavelength | 343 nm (3^{rd} harmonic) | | 1030 | nm |
| Pulse width | 300 | fs | 300 | fs |
| Repetition rate | 50 | kHz | 200 | kHz |

| | | | |
|---|---|---|---|
| Average power | 1.5 | W | 1 W-4 W |

| Pulse energy | Up to 30 μJ | Up to 5 μJ-20 μJ | |
|---|---|---|---|
| Spot size | ~2.5 mm (non-focused) | 17 μm (focused) | |
| Scanning speed (Galvo) | — | 100 | mm/s |

| | | |
|---|---|---|
| Crosshatch pitch | — | 25 μJ (bidirectional) |

### Example Articles A25-A30: Irradiation and Subsequent Gradient or Isothermal Heat Treatment

### Articles A25 and A26

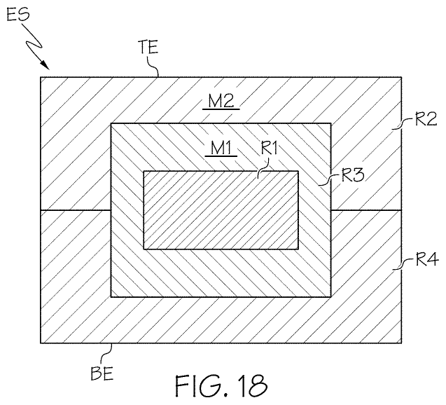

Referring now to Table 7 and FIG. 17, example samples ES as indicated in Table 7 were partially covered with a mask M such that the example samples ES had a first region R1 and a second region R2. The first region was irradiated with an X-ray source for the time indicated in Table 7. The X-ray source was the same X-ray source as described above with respect to example articles A1-A8.

After the irradiation, the mask M was removed and the example samples ES were subjected to a gradient heat treatment with a varying temperature from a top edge TE to bottom edge BE as indicated in Table 7 such that the example samples ES had a third region R3 and to produce example articles A25 and A26. The observable color of the first region R1 and the color measurements of the second region R2 (i.e., closer to the top edge TE) and the third region R3 (i.e., closer to the bottom edge BE) of example articles A25 and A26 are listed in Table 7.

| | | |
|---|---|---|
| Article | A25 | A26 |

| Example sample | | | E4 | E4 |
|---|---|---|---|---|
| Irradiation time | | | 15 min. | 15 min. |
| Gradient heat | | | Varying | Varying |
| treatment | | | 660° C. to | 610° C. to |
| | | | 600° C. for | 560° C. for |
| | | | 2 hrs. | 2 hrs. |
| R1 color | | | clear | clear |
| | R2 color | L* | 89 | 85 |
| | | a* | −3.7 | −3 |
| | | b* | −1 | −5 |
| | R3 color | L* | 84 | 83 |
| | | a* | 0.3 | 8 |
| | | b* | −6 | −9 |

### Articles A27 and A28

Referring back to FIG. 17 and Table 8, example samples ES as indicated in Table 8 were subjected to a gradient heat treatment with a varying temperature from a top edge TE to bottom edge BE listed in Table 8 such that the example sample ES had a second region R2 and a third region R3.

After the gradient heat treatment, the example samples ES were partially covered with a mask M such that the example samples ES had a first region R1. The first region R1 was irradiated with an X-ray source for the time indicated in Table 8. The X-ray source was the same X-ray source described above with respect to example articles A1-A8.

After the irradiation, the mask M was removed and the example samples ES were subjected to an isothermal heat treatment as indicated in Table 8 to provide example articles A27 and A28. The observable colors of the first region R1, the second region R2 (i.e., closer to the top edge TE), and the third region (i.e., closer to the bottom edge BE) of example articles A27 and A28 are listed in Table 8.

| Article | A27 | A28 |
|---|---|---|
| Example sample | E4 | E4 |
| Gradient heat treatment | Varying | Varying |
| | 660° C. to | 610° C. to |
| | 600° C. for | 560° C. for |
| | 2 hrs. | 2 hrs. |
| Irradiation time | 15 min. | 15 min. |
| Isothermal heat treatment | 545° C. for | 545° C. for |
| | 2 hrs. | 2 hrs. |
| R1 color | pink | pink |
| R2 color | green | blue |
| R3 color | blue | pink |

Referring now to Table 9 and FIG. 18, example samples ES as indicated in Table 9 were partially covered with a first mask M1 such that the example ES had a first region R1 and a second region R2. The first region was irradiated with a first X-ray source for the time indicated in Table 9. The first X-ray source was the same X-ray source as described above with respect to example articles A1-A8.

After the first irradiation, the first mask M1 was removed and the example samples ES were subjected to an isothermal heat treatment as indicated in Table 9.

After the isothermal heat treatment, the example samples ES were partially covered with a second mask M2 such that the example samples ES had a third region R3. The first region R1 and the third region R3 were irradiated with a second X-ray source for the time indicated in Table 9. The second X-ray source was the same X-ray source as described above with respect to example articles A1-A8.

After the second irradiation, the second mask M2 was removed and the example samples ES were subjected to a gradient heat treatment with a varying temperature from a top edge TE to bottom edge BE as indicated in Table 9 such that the example sample ES had a fourth region R4 and to produce example articles A29 and A30. The observable colors of the first region R1, the second region R2 (i.e., closer to the top edge TE), the third region R3, and the fourth region R4 (i.e., closer to the bottom edge BE) of example articles A25 and A26 are listed in Table 9.

TABLE 9

| Article | A29 | A30 |
|---|---|---|
| Example sample | E4 | E4 |
| First irradiation time | 5 min. | 10 min. |
| Isothermal heat treatment | 575° C. for | 575° C. for |
| | 8 hrs. | 8 hrs. |
| Second irradiation time | 15 min. | 15 min. |
| Gradient heat treatment | Varying | Varying |
| | 660° C. to | 610° C. to |
| | 600° C. for | 560° C. for |
| | 2 hrs. | 2 hrs. |
| R1 color | clear | clear |
| R2 color | pink | purple and pink |
| R3 color | light pink | pink |
| R4 color | purple and pink | blue |

### Example Articles A31-A48: Isothermal Heat Treatment and Subsequent Irradiation

### Articles A31-A35

Referring back to FIG. 13 and to Table 10, example samples ES as indicated in Table 10 were subjected to a first isothermal heat treatment as indicated in Table 10.

After the first isothermal heat treatment, the example samples ES were covered with a mask M such that the example samples ES had a first region R1 and a second region R2. The first region R1 was irradiated with an X-ray source for the time indicated in Table 10. The X-ray source was the same X-ray source as described above with respect to example articles A1-A8.

After the irradiation, the example samples ES were subjected to a second isothermal heat treatment as indicated in Table 10 to produce example articles A31-A35. The color measurements or observable color of the first region R1 and the second region R2 of example articles A31-A35 are listed in Table 10.

TABLE 10

| Article | | A31 | A32 | A33 | A34 | A35 |
|---|---|---|---|---|---|---|
| Example sample | | E5 | E5 | E5 | E5 | E6 |
| First isothermal | | 545° C. for | 545° C. for | 545° C. for | 545° C. for | 545° C. for |
| heat treatment | | 2 hrs. | 2 hrs. | 2 hrs. | 2 hrs. | 2 hrs. |
| Irradiation time | | 15 min. | 15 min. | 15 min. | 15 min. | 15 min. |
| Second isothermal | | 560° C. for | 575° C. for | 575° C. for | 625° C. for | 575° C. for |
| heat treatment | | 2 hrs. | 2 hrs. | 8 hrs. | 2 hrs. | 8 hrs. |
| R1 color | | L* = 91.45 | L* = 91.69 | L* = 92.29 | negligible | L* = 90.62 |
| | | a* = 3.46 | a* = 3.47 | a* = 4.10 | observable | a* = 4.19 |
| | | b* = −0.84 | b* = −0.26 | b* = 0.88 | difference | b* = −2.42 |
| | | | | | with R2 | |
| R2 color | L* | 89.92 | 89.66 | 90.90 | 90.47 | 89.87 |
| | a* | 2.57 | 1.79 | 3.29 | −0.09 | 0.08 |
| | b* | −3.76 | −3.91 | −1.69 | −2.76 | −3.84 |

### Articles A36-A48

Referring now to Table 11, example samples as indicated in Table 11 were subjected to a first isothermal heat treatment as indicated in Table 11.

After the first isothermal heat treatment, a portion of the example samples were irradiated with a UV source or an IR source as indicated in Table 5 such that the example samples had a first region R1 (i.e., irradiated portion) and a second region R2 (i.e., non-irradiated portion). Table 6 lists further parameters of the UV source and the IR source. After the irradiation, the example samples were subjected to a second isothermal heat treatment as indicated in Table 11 to produce example articles A36-A48. The observable colors of or damage to the first region R1 and color measurements of the second region R2 of the example articles A36-A48 are listed in Table 11.

TABLE 11

| Article | | A36 | A37 | A38 | A39 | A40 | A41 |
|---|---|---|---|---|---|---|---|
| Example sample | | E10 | E10 | E10 | E10 | E10 | E10 |
| First isothermal | | 545° C. | 545° C. | 545° C. | 545° C. | 545° C. | 545° C. |
| heat treatment | | for 2 hrs. | for 2 hrs. | for 2 hrs. | for 2 hrs. | for 2 hrs. | for 2 hrs. |
| Irradiation | | UV at 8 W | UV at 8 W | UV at 10 W | IR at 2 W | IR at 1.5 W | IR at 1 W |
| | | for 1 min. | for 5 min. | for 1 min. | | | |
| Second isothermal | | 575° C. | 575° C. | 575° C. | 575° C. | 575° C. | 575° C. |
| heat treatment | | for 2 hrs. | for 2 hrs. | for 2 hrs. | for 2 hrs. | for 2 hrs. | for 2 hrs. |
| R1 color | | negligible | negligible | negligible | color | color | clear |
| | | observable | observable | observable | lighter than | lighter than | |
| | | difference | difference | difference | color of R2 | color of R2 | |
| | | with R2 | with R2 | with R2 | | | |
| R2 color | L* | 90.84 | 90.84 | 90.84 | 90.84 | 90.84 | 90.84 |
| | a* | 2.45 | 2.45 | 2.45 | 2.45 | 2.45 | 2.45 |
| | b* | −2.53 | −2.53 | −2.53 | −2.53 | −2.53 | −2.53 |

| Article | | A42 | A43 | A44 | A45 | A46 | A47 |
|---|---|---|---|---|---|---|---|
| Example sample | | E10 | E10 | E10 | E10 | E10 | E10 |
| First isothermal | | 545° C. | 545° C. | 545° C. | 545° C. | 545° C. | 545° C. |
| heat treatment | | for 2 hrs. | for 2 hrs. | for 2 hrs. | for 2 hrs. | for 2 hrs. | for 2 hrs. |
| Irradiation | | IR with | IR with | IR with | IR at 2 W | IR at 2.5 W | IR at 3 W |
| | | varied duty | varied duty | varied duty | | | |
| | | cycle at | cycle at | cycle at | | | |
| | | 70% of 4 W | 50% of 4 W | 30% of 4 W | | | |
| Second isothermal | | 575° C. | 575° C. | 575° C. | 575° C. | 575° C. | 575° C. |
| heat treatment | | for 2 hrs. | for 2 hrs. | for 2 hrs. | for 2 hrs. | for 2 hrs. | for 2 hrs. |
| R1 color | | resulting | resulting | resulting | clear | clear | resulting |
| | | surface | surface | surface | | | surface |
| | | damage | damage | damage | | | damage |
| R2 color | L* | 90.84 | 90.84 | 90.84 | 90.84 | 90.84 | 90.84 |
| | a* | 2.45 | 2.45 | 2.45 | 2.45 | 2.45 | 2.45 |
| | b* | −2.53 | −2.53 | −2.53 | −2.53 | −2.53 | −2.53 |

As exemplified by example articles A1-A47, the methods described herein including a combination of irradiating and subjecting a glass substrate to heat treatment produces multi-colored glass substrates, the colors and patterns of which are based on the radiation exposure and the heat treatment conditions.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A method of forming a multi-colored glass substrate, the method comprising:
irradiating a first region of a glass substrate with a first high energy source to form a first irradiated glass substrate; and
subjecting the first irradiated glass substrate to a first heat treatment to form a first heat treated glass substrate,
wherein the first heat treated glass substrate comprises a second region having a different transmittance color coordinate in the CIELAB color space, as measured at an article thickness of 1.33 mm under F2 illumination and a 10° standard observer angle, than the first region.

2. The method of claim 1, wherein the first high energy source comprises an X-ray source or an ultrafast laser beam.

3. The method of claim 2, wherein the X-ray source has a wavelength greater than or equal to 0.01 nm and less than or equal to 10 nm and a power less than or equal to 4000 W.

4. The method of claim 2, wherein the ultrafast laser beam has a pulse width greater than or equal to 10⁻¹² s and less than or equal to 10⁻¹⁵ s, a peak intensity greater than or equal to 10¹³ W/cm², a wavelength greater than or equal to greater than or equal 300 nm and less than or equal to 1100 nm, a pulse energy greater than or equal to 0.5 μJ and less than or equal to 30 μJ and a peak power greater than or equal to 0.05 MW and less than or equal to 20 MW.

5. The method of claim 1, wherein the irradiating the glass substrate is conducted for a time period greater than or equal to 0.001 hours and less than or equal to 1 hour.

6. The method of claim 1, wherein the first heat treatment comprises an isothermal heat treatment or a gradient heat treatment.

7. The method of claim 1, wherein the first heat treatment is conducted at a temperature of greater than or equal to 500° C. to 900° C. and for a time period greater than or equal to 0.5 hours and less than or equal to 12 hours.

8. The method of claim 1, wherein the glass substrate comprises Au.

9. The method of claim 1, the method further comprising disposing a first mask between the glass substrate and the first high energy source prior to irradiating the glass substrate to form the second region, wherein the first mask is opaque to the first high energy source.

10. The method of claim 1, the method further comprising further comprising strengthening the glass substrate in an ion-exchange bath at a temperature greater than or equal to 350° C. to less than or equal to 500° C. for a time period greater than or equal to 2 hours to less than or equal to 12 hours to form an ion-exchanged glass substrate.

11. A method of forming a multi-colored glass substrate, the method comprising:
subjecting a glass substrate to a first heat treatment to form a first heat treated glass substrate; and
irradiating a first region of the first heat treated glass substrate with a first high energy source to form a first irradiated glass substrate,
wherein the first irradiated glass substrate comprises a second region having a different transmittance color coordinate in the CIELAB color space, as measured at an article thickness of 1.33 mm under F2 illumination and a 10° standard observer angle, than the first region.

12. The method of claim 11, wherein the first high energy source comprises an X-ray source or an ultrafast laser beam.

13. The method of claim 12, wherein the X-ray source has a wavelength greater than or equal to 0.01 nm and less than or equal to 10 nm and a power less than or equal to 4000 W.

14. The method of claim 12, wherein the ultrafast laser beam has a pulse width greater than or equal to 10⁻¹² s and less than or equal to 10⁻¹⁵ s, a peak intensity greater than or equal to 10¹³ W/cm², a wavelength greater than or equal to greater than or equal 300 nm and less than or equal to 1100 nm, a pulse energy greater than or equal to 0.5 μJ and less than or equal to 30 μJ, a peak power greater than or equal to 0.05 MW and less than or equal to 20 MW.

15. The method of claim 11, wherein the irradiating the glass substrate is conducted for a time period greater than or equal to 0.001 hours and less than or equal to 1 hour.

16. The method of claim 11, wherein the first heat treatment comprises an isothermal heat treatment or a gradient heat treatment.

17. The method of claim 11, wherein the first heat treatment is conducted at a temperature of greater than or equal to 500° C. to 900° C. and for a time period greater than or equal to 0.5 hours and less than or equal to 12 hours.

18. The method of claim 11, wherein the glass substrate comprises Au.

19. The method of claim 11, the method further comprising disposing a first mask between the first heat treated glass substrate and the first high energy source prior to irradiating the first heat treated glass substrate to form the second region, wherein the first mask is opaque to the first high energy light source.

20. The method of claim 11, the method further comprising further comprising strengthening the glass substrate in an ion-exchange bath at a temperature greater than or equal to 350° C. to less than or equal to 500° C. for a time period greater than or equal to 2 hours to less than or equal to 12 hours to form an ion-exchanged glass substrate.
